(19) United States
(12) Patent Application Publication
(10) Pub. No.: US 2005/0264070 A1
(43) Pub. Date: Dec. 1, 2005

(54) Electric erecting chair

(76) Inventors: Chin-Chin Kao, Sindian City (TW); Yu-Yao Lin, Sindian City (TW)

Correspondence Address: Yi-Wen Tseng, 4331 Stevens Battle Lane, Fairfax, VA, 22033, US

(21) Appl. No.: 10/852,477

(22) Filed: May 25, 2004

(51) Int. Cl. A61G 15/00; A47C 3/027; A47C 7/14

(52) U.S. Cl. 297/284.11

(57) ABSTRACT

An electric erecting chair includes a support member, a backrest, a pair of arms, a cushion and an electric erecting mechanism The support member has a first connecting structure at each side thereof and a second connecting structure at the rear end of each side. The backrest has a connecting structure detachably connected to the second connecting structure of the support member. The pair of arms is detachably connected to the first connecting structure. The cushion is disposed on the support member and the electric erecting mechanism disposed under cushion the operative to push a front portion of the cushion upwardly.

### BACKGROUND OF THE INVENTION

The present invention relates in general to an improved structure of an electric erecting chair, and more particularly, to a detachable electric erecting chair of which the volume for packaging and transportation is reduced.

Currently, the electric erecting chair includes a support member, a cushion, an electric erecting mechanism, a backrest two arms and a control apparatus fixed with each other. When an injured or disable user sits on the chair for a period of time, the electric erecting mechanism is operative to push a front portion of the cushion upwardly, so as to assist the user to stand up. The electric erecting mechanism utilizes a hydraulic tank to push the cushion upwardly.

Although the electric erecting chair is a very convenient tool for injured or disable user, as the backrest and the arms are permanently fixed to the support member, a significant volume is occupied for storage and transportation.

### BRIEF SUMMARY OF THE INVENTION

The present invention provides an electric erecting chair of which the backrest and the arms are detachable. Therefore, the space for storage and transportation of the chair are greatly reduced

The electric erecting chair provided by the present invention includes a support member, a backrest, a pair of arms, a cushion and an electric erecting mechanism. The support member includes a first connecting structure at each side thereof and a second connecting structure at the rear end of each side. The backrest includes a connecting structure detachably connected to the second connecting structure of the support member. The pair of arms is detachably connected to the first connecting structures. The cushion disposed on the support member. The electric erecting mechanism disposed under cushion the operative to push a front portion of the cushion upwardly.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed

### BRIEF DESCRIPTION OF THE DRAWINGS

The above objects and advantages of the present invention will be become more apparent by describing in detail exemplary embodiments thereof with reference to the attached drawings in which:

FIG. 1 depicts the perspective view of an electric erecting chair,

FIG. 2 shows an exploded view of the backrest and the support member of the electric erecting chair,

FIG. 3 shows an exploded view of the arms and the support member, and

FIG. 4 shows the application of the electric erecting chair.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

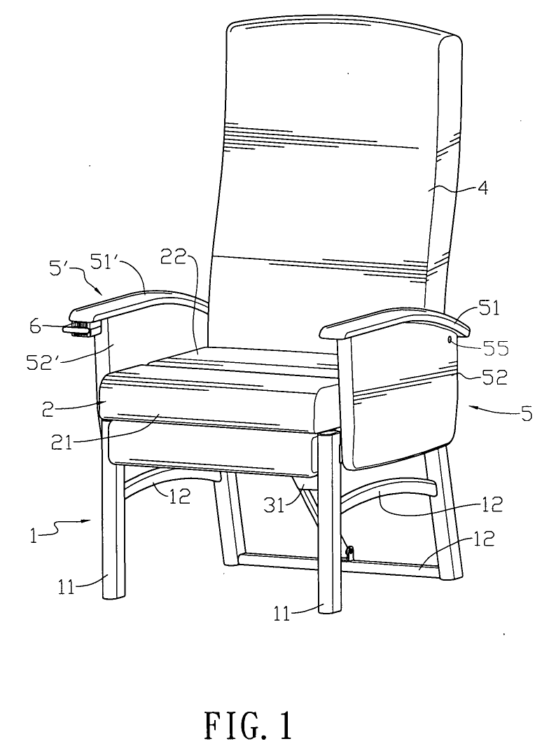

Referring to FIG. 1, a perspective view of an electric erecting chair is shown. The electric erecting chair includes a support member 1, a cushion 2 disposed on the support member 1, an erecting mechanism 3 under the cushion 2, a backrest 4 projecting from one end of the support member 1, and a pair of arms 5, 5′ connected to both the support member 1 and the backrest 4. The electric erecting chair further includes a control apparatus 6 installed in the arm 5′. The back rest 4 and the arms 5, 5′ are detachable from the support member 1, such that less packaging material is used for the electric erecting chair. Therefore, the cost for packing and transportation is reduced.

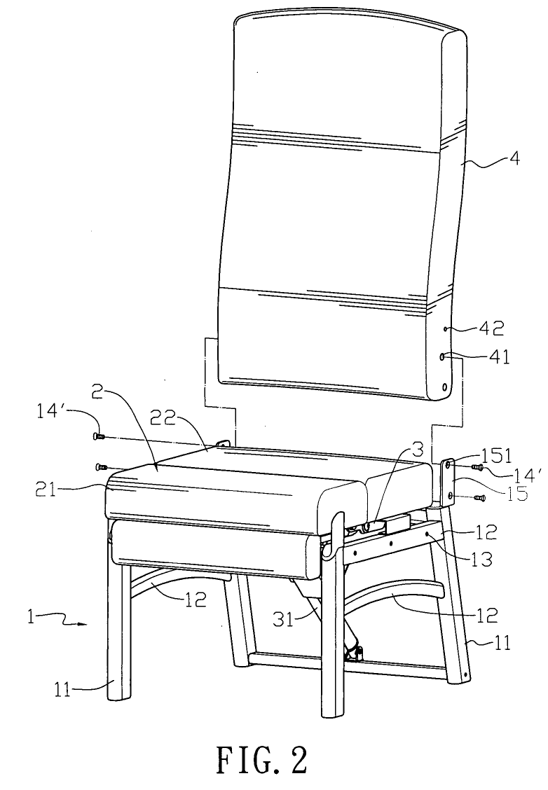

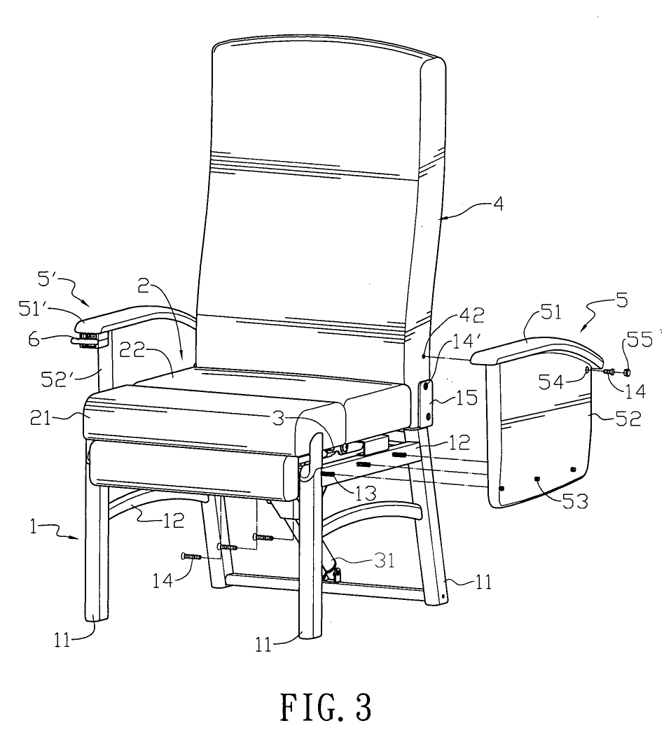

Referring to FIGS. 2 and 3, exploded views of backrest 4, arms 5, 5′ and the support member 1 are illustrated. The support member 1 includes a plurality of legs 11 and a plurality of bars 12 extending transversely between the legs 11. In the embodiment as shown in FIG. 2, the chair includes two pair of legs 11 extending substantially vertically at each side of the chair. At each side of the chair, an upper bar 12 and a lower bar 12 extend horizontally between the pair of legs 11. Holes 13 are formed in the upper bars 12 at both sides of the chair. Preferably, the interior surfaces of the holes 13 are threaded to allow fasteners 14 such as screws to thread therewith. The arms 5 and 5′ also include a plurality of holes 53 extending therethrough. To assembly the arms 5 and 5′ to the support member 1, the holes 53 are aligned with the corresponding holes 13, and the arms 5 and 5′ are secured to the upper bars 12 of the support member 1 by threading the fasteners 14 through the holes 53 and 13. Extending upwardly from the rear leg 11 of each side of the chair is a connecting member 15. The connecting member 15 is perforated with at least one hole 151 allowing a fastener 14′ to extend through. Holes 41 are also formed on each side of the backrest 4, such that by aligning the holes 151 with the holes 41, the backrest 4 can be secured to the support member 1 by threading the fasteners 14′ with the holes 41 and 151.

The cushion member 2 includes a front cushion 21 and a rear cushion 22 pivotally connected to each other. The electric erecting mechanism 3 includes a push bar extending towards a bottom of the front cushion 21. Therefore, when the push bar is driven to move upwardly, the front cushion 21 is pushed upwardly to erect the user sitting on the chair.

The backrest 4 further includes at least one hole 42 formed at each side surface thereof, and the arms 5 and 5′ each comprises a through hole 54 formed at an upper portion thereof. Therefore, the arms 5 and 5′ can be attached to the backrest 4 by fasteners 14.

The arms 5 and 5′ comprise vertical members 52 and 52′, and armrests 51 and 51′ on the top edges of the vertical members 52 and 52′, respectively. In this embodiment, the holes 53 and 54 are formed through the vertical members 52 and 52′. When the arms 5 and 5′ are secured to the support member 1 and the backrest 4, covering members 55 are attached to the fasteners 14 for aesthetic purpose.

The control apparatus 6 is installed between the armrest 51′ and the vertical member 52′ of the arm 5′. When the user is operating the control apparatus 6, the electric erecting member 3 is activated to assist the user, particularly a person with injury or disability at legs or back, to stand up.

To install the chair, fasteners 14′ are used to assembly the backrest 4 with the connecting members 15 of the support member 1. Fasteners 14 are then used to extend through the vertical members 52, 52′ into the upper bars 12, so as to secure the arms 5, 5′ with the support member 1. Another fasteners 14 are further used to secure the arms 5, 5′ with the backrest 4. When the arms 5 and 5′ are secured with the backrest 4 and 4′ by the fasteners 14, covering members 55 are used to cover the fasteners 14.

To disassemble the electric erecting chair, the arms 5, 5′ are detached by disengaging the fasteners 14 from the backrest 4 and the upper bars 12. The fasteners 14′ are then removed from the connecting members 15 and the backrest 4. Thereby, the backrest 14 and the arms 5, 5′ are completely separated from the support member 1, such that a smaller space is required to package all the members of the chair for transportation or storage.

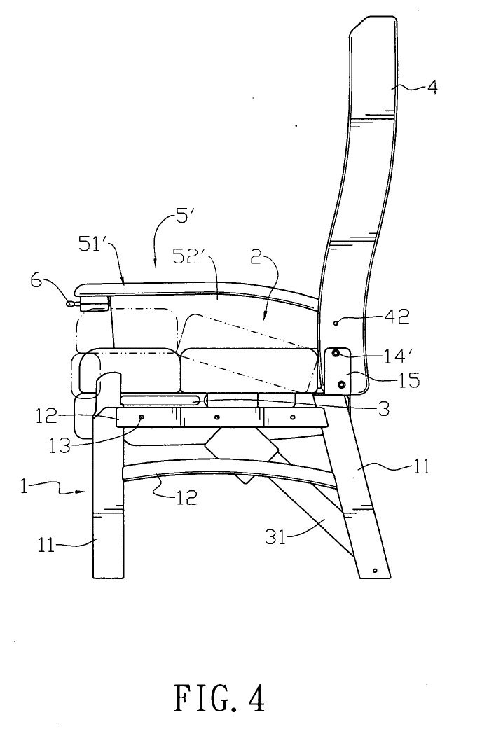

Referring to FIG. 4, to assist the user to stand up, the user can control the control apparatus 6 for activate the hydraulic tank 31, which then driven the push arm adjacent to the front cushion 21 moving upwardly, so as to push the front cushion 21 upwardly. The upward movement of the front cushion 21 provides an upward erecting force to help the user to stand up from the chair.

In addition to the fasteners 14 and 14′, snapping or frictional fit structures can also be used to connect the backrest 4, the arms 5 and 5′ to the support member 1.

A plurality of holes 53 may be formed at various levels of the vertical members 53 of the arms 5, 5′, such that the position of the arms 5, 5′ can be adjusted as required.

While the present invention has been particularly shown and described with reference to preferred embodiments thereof, it will be understood by those of ordinary skill in the art the various changes in form and details may be made therein without departing from the spirit and scope of the present invention as defined by the appended claims.

1. An electric erecting chair, comprising:
a support member, comprising at least one hole in each side and one connecting member projecting from one end of each side thereof, the connecting member comprising at least one hole extending therethrough;
a backrest having at least one thread hole formed at each side thereof;
two arms each comprising a vertical member and an arm rest, wherein each of the vertical member comprising a through hole extending therethrough; and
a first plurality of fasteners extending through the through hole of the connecting member into the threaded hole of the backrest to secure the backrest with the support member, and a second plurality of fasteners extending through the through hole of the vertical members into the holes formed in the support member to secure the arms with the support member.

2. The chair of claim 1, wherein the backrest further comprising an additional threaded hole at each side thereof and each of the arms further comprises an additional through hole aligned with the additional threaded hole of the backrest.

3. The chair of claim 1, further comprising a third plurality of fasteners extending through the additional through holes of the arms and the additional threaded holes of the backrest to secure the arms to the backrest.

4. The chair of claim 1, wherein the support member comprises a plurality of legs and a plurality bars extending horizontally between the legs.

5. The chair of claim 4, wherein the bars include one upper bar extending between a pair of the legs at each side of the chair.

6. The chair of claim 1, further comprising a cushion disposed on the support member.

7. The chair of claim 6, further comprising an electric erecting member to push a front portion of the cushion upwardly.

8. The chair of claim 6, wherein the cushion includes a front cushion member and a rear cushion member pivotally connected to each other.

9. The chair of claim 1, further comprising an electric erecting mechanism between the support member and the cushion.

10. The chair of claim 1, wherein the through holes are formed at various levels of the vertical members of the arms, such that the height of the armrests is adjustable.

11. The chair of claim 1, wherein the fasteners comprise screws.

12. An electric erecting chair, comprising:
a support member having a first connecting structure at each side thereof and a second connecting structure at the rear end of each side;
a backrest, having a connecting structure detachably connected to the second connecting structure of the support member,
a pair of arms detachably connected to the first connecting structures;
a cushion disposed on the support member, and
an electric erecting mechanism operative to push a front portion of the cushion upwardly.
